(19) United States
(12) Patent Application Publication
(10) Pub. No.: US 2011/0137708 A1
(43) Pub. Date: Jun. 9, 2011

(54) Prioritized Promising with Preemption in Supply Chains

(75) Inventors: Narayan Venkatasubramanyan, Coppell, TX (US); Srinivasan Kumar, Sunnyvale, CA (US); Amarinder P. Singh, Burlingame, CA (US)

(73) Assignee: Amitive, San Mateo, CA (US)

(21) Appl. No.: 12/630,016

(22) Filed: Dec. 3, 2009

(51) Int. Cl. G06Q 10/00

(52) U.S. Cl. 705/7.31; 705/28; 705/7.25

(57) ABSTRACT

A supply chain management plan includes supply events for inventory and times at which the supplies will be received. The plan further includes demand events and when they occur. The demands may be prioritized. For each demand priority, an available to promise (ATP) amount of supply is determined in accordance with demand events of that priority. The ATP is determined for higher priority demand events before it is determined for lower priority demand events. Cancellations of a priority k order may be processed by determining, for each demand priority context i=k+1 to N, an amount of inventory to restore to available status at a particular supply event based upon a minimum ATPRG value between the particular supply event and the order committed date.

### BACKGROUND

Traditionally, the tactical planning of a supply chain has been divided into two parts. These two parts are “planning” and “promising”. Planning is a periodic activity, which results in the creation of a plan that is feasible with respect to constraints that are known at that time. Promising is a continuous activity which is triggered by the arrival or cancellation of requests.

A plan for an item at a facility comprises expected inflows and outflows, each inflow specifying both the quantity and the time of arrival, and each outflow specifying both the quantity and the time of departure. When a plan is created, the net availability may be published as ATP (“Available to Promise”). ATP serves as a basis for promising. ATP may comprise a list of time-quantity pairs in chronological order, each element of which may specify additional quantity available at that point in time. Requests are promised in the sequence in which they are received.

A request is received for a certain quantity at a certain time (at that item and facility). One traditional approach starts at the time when the request is due and scans backward in time, picking up some or all of the ATP until either the requested quantity has been found or all ATP prior to the due date has been consumed. If the latter, the promising algorithm scans forward in time starting at the request date, and consumes some or all of the ATP, until either the requested quantity has been found or all ATP has been consumed. If the latter, the request cannot be fulfilled completely. This promising algorithm ensures that a new order is promised as close to its request date as possible, without violating prior commitments.

Cancellations can occur in different forms. A customer may cancel an order that had been promised for a specific quantity at a specific time (for that item and facility). Alternatively, a quote may expire, and this will be treated as if an order were canceled. The effect of a cancellation is the mirror image of the effect of a promise. That is, the ATP needs to be restored in such a way that permits future promises against the released material. Traditionally, there have been different approaches to doing this. According to conventional thinking, the computational effort required to restore ATP “optimally” is too expensive to be implemented in a real-time manner. Therefore, traditional ATP restoration algorithms have been heuristic and hence sub-optimal.

In real world supply chains, there is an additional complication: demands can be in different categories (based on customer type, product etc.) and receive preferential treatment based on their category relative to demand in other categories. In such cases, the traditional approach has been to enhance the planning-promising framework to include an intermediate step of allocation. The allocations are often referred to as Allocated Available to Promise (“AATP”).

In one simple case, planned replenishments are partitioned into as many different buckets as there are demand categories. When a request that belongs to a particular category arrives, the promise that is made in response is done from the availability that has been allocated to that demand category. This ensures that a certain amount of supply is reserved for each category.

In more complicated cases, the relative importance of these categories is used to allow requests that belong to a category to steal from the allocations made to another category. In the extreme case, stealing is allowed even if it comes at the expense of other promises made in a lower priority category. This is usually called pre-emption.

Traditionally, the plan specifies the timing and quantity of replenishments. This stream of replenishments is used to meet all the requests that are received until the next planning cycle.

In order to be able to treat requests of different priorities differently, replenishments are assigned to pools of availability. Each replenishment is fragmented into a set of smaller replenishments, each going into a different pool. This partitioning is done upon the completion of planning. The size of each partition is determined using rules specified by the user. When a request is received, its priority determines which pools are available to it for the purpose of promising. User-specified rules determine the sequence in which these pools are searched.

The onus of determining how the available supply is partitioned across the pools of availability is left to the user. Sometimes the planned replenishments fail to match the demand placed on the supply chain. In this case, the user has to pre-determine how promising should be done during moments of projected scarcity. The user must balance several conflicting and non-commensurate requirements such as demand priority, forecast quantity, due date etc. In order to enable the user to do so, current systems offer a host of parameters and flags. Therefore, the burden of judicious allocation is pushed to the user.

Partitioning of available supply across these pools is done once, at the time of planning. The actual pattern of demand may differ greatly from what was forecast, but the allocations will remain unaffected except when overridden by the user. The system cannot adapt to the shifting demand patterns, which may result in sub-optimal outcomes.

Traditionally, the priority of a request is designated by an ordinal number, e.g. 1, 2, 3 . . . A lower number indicates a higher priority. In other words, an order that has been assigned a priority of 1 is more important than one that has been assigned a priority of 3 even if the former arrives after a promise has been made to the latter.

For example, assume that orders of priority i and j (i<j) are allocated to the same pool. Assume that requests of priority j consume the contents of the pool before the arrival of a request of priority i. In that case, that request will be denied or delayed even though it has a higher priority than the requests already promised. Typically, this sub-optimal promise will be rectified only at the time of the next planning cycle. At that time, one or more of the priority j requests will be denied or delayed.

Assume that orders of priority i and j (i<j) are allocated to different pools (say pools 1 and 2 respectively). Assume that requests of priority j consume the contents of the pool 2; meanwhile, requests of priority i lag the forecast and as a result fail to consume the pool 1. In such a case, subsequent requests of priority j will be denied or delayed even though they can be satisfied from the pool 1. Typically, such a problem would be fixed only during the next planning cycle when the forecasts of priority i are reduced by user action.

To summarize, traditional methods may freeze allocations at the end of each planning cycle, thereby ignoring the dynamic nature of the demand. By freezing allocations these methods avoid the complications of reneging on commitments to requests of lower priority when a request of higher priority arrives.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is an illustration of an exemplary projected inventory balance.

FIG. 2 is a flow chart of an embodiment of a process of determining ATP, NATP and ATPRG.

FIG. 3 is a flow chart of an embodiment of a high-level process of allocating inventory to prioritized demand.

FIG. 4 is a flow chart of an embodiment of a process of allocating inventory to prioritized demand.

FIG. 5 is a flow chart of an embodiment of a process for making the plan for a particular priority feasible.

FIG. 6 illustrates an exemplary embodiment of an apparatus to implement aspects of the supply chain management techniques described herein.

FIG. 7 illustrates a more detailed exemplary embodiment of an apparatus to implement aspects of the supply chain management techniques described herein.

### DETAILED DESCRIPTION

### Preliminaries

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

Herein the term “optimal” is sometimes used in reference to results of certain operations. The term refers to the results being the best that can be achieved for certain specific parameters and circumstances, not necessarily the best possible result overall.

### Overview

The patent application entitled EFFICIENT COMPUTATION OF AVAILABLE TO PROMISE (ATP) IN SUPPLY CHAINS, having application Ser. No. 12/339,436, filed on Dec. 19, 2008 (henceforth, the “'436 application”) is incorporated by reference herein in its entirety. The '436 application introduces the notion of ATP, NATP, and ATPRG, among other things. The approaches described in the '436 application provide for optimal promising in the absence of demand priorities. Pre-emption is one approach to dealing with demands of distinct priorities. This application builds upon the approach described in the '436 patent application in the presence of priority demands.

In the approach described in the '436 patent application, a plan assumes a fixed set of supplies. All orders are treated as having the same priority, distinguished only by their due dates. A new order is promised as close to its request date as possible, without violating prior commitments. That is, an order is not allowed to “elbow out” other orders that had already been committed. Cancellations restore availability as early as is feasible so that subsequent promising is done optimally.

The projected inventory (uncommitted) is determined throughout the planning horizon for a given set of planned supplies and commitments. Using this profile of projected inventory, determine Available to Promise (ATP), Not Available to Promise (NATP) and ATP Restoration Guide (ATPRG). Use the ATP to make promises to new requests and updated ATP, NATP and ATPRG after making those commitments. Use ATPRG to restore inventory released by cancellation of orders and update ATP, NATP and ATPRG after making those cancellations.

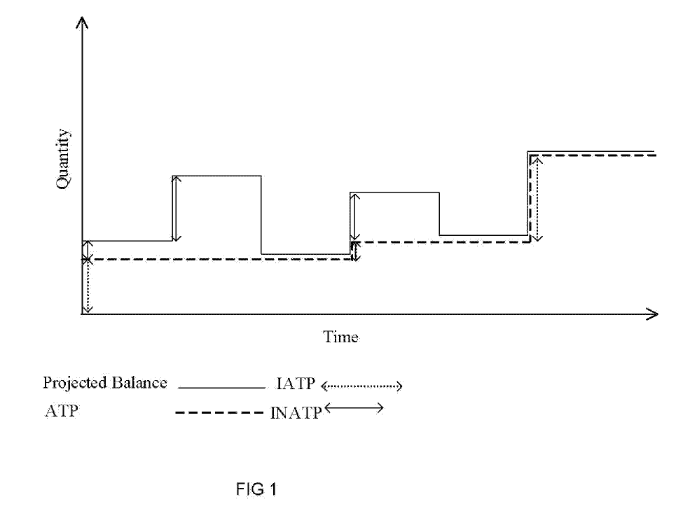

In FIG. 1, the solid horizontal line denotes the projected balance in an exemplary inventory balance. It increases at times when there is a supply and decreases when there is a commitment. As long as the solid line stays above the Time axis, the set of commitments that have been made are feasible. This horizontal dashed line represents the ATP. As long as any new commitment at time t does not exceed the ATP at time t, the solid horizontal line will continue to remain above the Time axis. That is, the commitment will continue to be feasible. The incremental ATP (IATP) at time t is a portion of the supply at time t that isn't committed to some demand at t or after t. This means that the portion of the supply that is committed to some demand at or after time t is not available and hence is part of the incremental NATP (INATP).

The NATP and ATPRG are not illustrated in the picture above. NATP is simply the accumulation of INATP over time. ATPRG is the difference between the NATP and the cumulative committed demand.

In the exemplary inventory balance of FIG. 1, all demand is treated as the same except for its due date and quantity. In more complicated situations, demands may be in different categories (based on customer type, product, etc.) and receive preferential treatment based on their category relative to those in other categories.

Preemption is an extreme example of preferential treatment to requests based on their priority. Under this regime, a request for priority k may pre-empt prior commitments made to requests of lower priority (i.e. k+1 and beyond) if doing so would allow it to be promised closer to the requested date than otherwise.

The term “engine” is used throughout to refer to the information (data) context associated with supply and demands of a particular priority level. “Engine” also comprises logic associated with a particular priority level. In some embodiments, the logic is essentially unchanged for different priority levels (e.g. an instance of the same logic is used for all engines), the difference between engines then being differences in the data context for different priority levels.

An apparatus to provide supply chain management may receive signals representing:
a. supply events for real world objects that specify the quantities of the objects and times at which the supply events will occur; and
b. demand events for the real world objects that specify the quantities of the objects and times at which the demand events will occur.

The demand events may have associated priorities. Typically, ordinal numbers (1, 2, 3 . . . ) are used to designate priorities; a demand of priority 1 is considered more important than a demand of priority 2, 3, and so on.

A plan for a particular inventory priority may include supply events comprising supply times and supply amounts, and demand events comprising demand times and demand amounts, where the demands have associated priorities. A context may be created in machine memory for each demand priority. The incremental ATP for demand priority context k is adjusted to account for the new demand event of priority k without regard to the ATP of other demand priority contexts. The demand priority contexts k+1 to N may be adjusted in response to the new demand event, where N is the number of demand priority contexts and priority k is higher than priority k+1. The incremental ATP for demand priority context k is applied to adjust the supply as seen by the demand priority context k+1, and hence the ATP of demand priority context k+1. Any demand priority context k+1 to N that is rendered infeasible by the new demand event is made feasible.

Other system/method/apparatus aspects are described in the text (e.g., detailed description and claims) and drawings forming the present application.

### DETAILED DESCRIPTION OF SOME EMBODIMENTS

It may become necessary to renege on commitments to demands of lower priority when a request of higher priority arrives. In this way the new request can be made as close to on-time and in full quantity as possible. Lower priority order commitments may be pushed out into the future, and/or reduced in quantity committed to make room for the late-coming higher priority request(s).

The following example will be used throughout this description.

TABLE 1
Planned supply and committed demand (by priority)

| | 1 | 2 | 3 | 4 | 5 | 6 | 7 | 8 | 9 | 10 | 11 | 12 | 13 |
|---|---|---|---|---|---|---|---|---|---|---|---|---|---|
| Planned Supply | 100 | | 90 | | 50 | | 30 | | 10 | | 30 | | |
| Committed Demand (1) | | 40 | | 20 | | 15 | | 10 | | 5 | | | |
| Committed Demand (2) | | 30 | | 10 | | 10 | | 5 | | 30 | | | |
| Committed Demand (3) | | 10 | | 30 | | 15 | | 5 | | 15 | | | |

Demands are split into three categories with (1) representing the highest priority and (3) the lowest. The set of commitments represented by TABLE 1 is feasible. This is because the cumulative supply is always greater than the cumulative demand. In other words, the projected inventory always remains non-negative. This is illustrated TABLE 2.

TABLE 2
Cumulative supply, aggregate cumulative demand, and projected inventory

| | 1 | 2 | 3 | 4 | 5 | 6 | 7 | 8 | 9 | 10 | 11 | 12 | 13 |
|---|---|---|---|---|---|---|---|---|---|---|---|---|---|
| Cumulative Supply | 100 | 100 | 190 | 190 | 240 | 240 | 270 | 270 | 280 | 280 | 310 | 310 | 310 |
| Cumulative Demand | 0 | 80 | 80 | 140 | 140 | 180 | 180 | 200 | 200 | 250 | 250 | 250 | 250 |
| Projected Inventory | 100 | 20 | 110 | 50 | 100 | 60 | 90 | 70 | 80 | 30 | 60 | 60 | 60 |

Under strict pre-emption, when making promises in response to new priority 1 demands, it is not necessary to consider prior commitments to lower priority demands. The only factors that determine the commitment to the new priority 1 demand are the planned supplies and any commitments made to priority 1 demands that were received before this one. The priority 1 engine takes into account all the planned supplies and only priority 1 demands. Context data such as ATP, NATP, ATPRG etc are determined using only priority 1 demands.

TABLE 3 shows an exemplary state of the promising engine for priority 1 demands.

TABLE 3
Initial state of ATP plan for priority 1 demands

| | 1 | 2 | 3 | 4 | 5 | 6 | 7 | 8 | 9 | 10 | 11 | 12 | 13 |
|---|---|---|---|---|---|---|---|---|---|---|---|---|---|
| Planned Supply | 100 | | 90 | | 50 | | 30 | | 10 | | 30 | | |
| Committed Demand (1) | | 40 | | 20 | | 15 | | 10 | | 5 | | | |
| Cum. Planned Supply | 100 | 100 | 190 | 190 | 240 | 240 | 270 | 270 | 280 | 280 | 310 | 310 | 310 |
| Cum. Committed Demand | 0 | 40 | 40 | 60 | 60 | 75 | 75 | 85 | 85 | 90 | 90 | 90 | 90 |
| Projected Inventory | 100 | 60 | 150 | 130 | 180 | 165 | 195 | 185 | 195 | 190 | 220 | 220 | 220 |
| ATP | 60 | 60 | 130 | 130 | 165 | 165 | 185 | 185 | 190 | 190 | 220 | 220 | 220 |
| NATP | 40 | 40 | 60 | 60 | 75 | 75 | 85 | 85 | 90 | 90 | 90 | 90 | 90 |
| Incremental ATP | 60 | 0 | 70 | 0 | 35 | 0 | 20 | 0 | 5 | 0 | 30 | 0 | 0 |

Future promises made against this plan (because it does not account for commitments to lower priority demands) will potentially create infeasibility if the material that it promises to that order has been committed to some lower priority order. Assuming strict pre-emption, any such infeasibility will be resolved by suitably adjusting a lower priority commitment (by delaying and or denying some or all of one or more earlier commitments).

Making promises when new demands requests of lower priority are received is more complicated than it is for requests of priority 1. Future demands of priority 2 or more are constrained by the commitments made to demands of higher priority. To address this complication, a plurality of promising engines is employed, one per priority. Priority 1 demands are serviced by engine 1. In general, demands of priority k are serviced by the k^{th} engine.

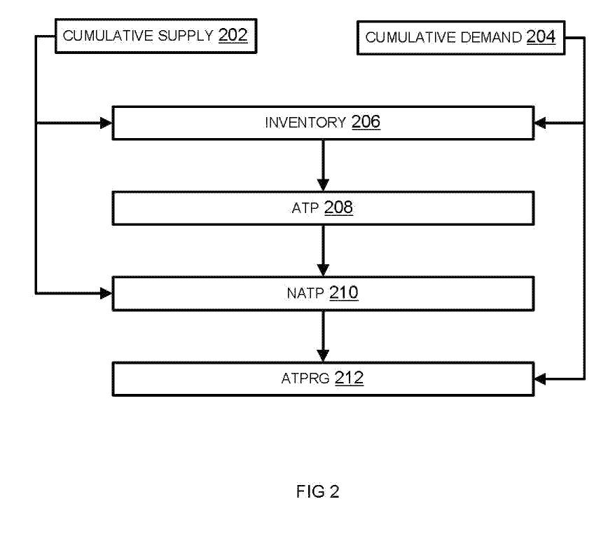

FIG. 2 is a flow chart of an embodiment of a process of determining various engine parameters. The context of each engine is determined by a series of planned supplies (specified by quantity and time) and a series of commitments or promises made to previously received demands (specified by quantity and time). The cumulative supply (202) and demand (204) may be determined from this information. The difference between supplies and demands at a given time is the projected inventory at that time (206). This serves as the basis of the computation of ATP (208). The difference between the cumulative supply and the ATP is the NATP (210). Finally, the difference between NATP and cumulative demand yields the ATPRG (212).

Prioritized promising is implemented with one engine per demand priority. Earlier commitments for lower priority demands should be respected as far as possible within limits of preemption.

The highest priority demands have the entire planned supply available to them.

The supply available to the second highest priority demands is the IATP of the priority 1 engine. In general, the supply available to the k^{th} priority demands is the IATP of the (k−1)^{th} priority engine.

Sₖ=Cumulative Planned supply for engine k

ATPₖ=ATP for engine k

NATPₖ=NATP for engine k

S₁ is the cumulative planned supply. In other words, the engine 1 has the entire supply available.

S₁=ATP₁+NATP₁

S₂=ATP₂+NATP₂

. . .

. . .

Sₖ=ATPₖ+NATPₖ

We choose Sₖ to be ATPₖ₋₁ and substitute it in the above equations. When we add these equations up, the terms ATP₁ through ATPₖ₋₁ cancel out, leaving the following.

S₁=ATPₖ+NATP₁+NATP₂+ . . . +NATPₖ

ATPₖ=S₁−(NATP₁+NATP₂+ . . . +NATPₖ)

Proof of the correctness of the choice of Sₖ

Two criteria need to be satisfied by the choice of Sₖ. It should not be “too much”. In other words, the ATP of the k^{th} engine should not be so high that it makes commitments to new demands of priority k that results in an infeasibility that can only be resolved by reneging on some earlier commitment to a demand of priority k or higher (i.e, k−1, k−2, . . . 3, 2, 1). It should not be “too little”. In other words, the ATP of the k^{th} engine should not be so low that it needlessly makes promises late or short to new demands of priority k.

Case 1: “too much”

Assume that we choose S₂=ATP₁, S₃=ATP₂, . . . , Sₖ₋₁=ATPₖ but Sₖ>ATPₖ₋₁

Assume that all ATPₖ is consumed by new demands of priority k. NATPₖ will be equal to Sₖ. NATP₁=S₁−ATP₁

NATP₂=S₂−ATP₂

. . .

NATPₖ=Sₖ−ATPₖ=Sₖ (because ATPₖ is now 0)

Adding these together gives:

NATP₁+NATP₂+ . . . +NATPₖ=S₁−(ATPₖ₋₁−Sₖ)>S₁

If there is no ATP in the k^{th} engine, the sum of all NATPs up to k ought to be equal to the total supply available. If Sₖ is allowed to exceed ATPₖ₋₁, the sum of the NATPs in the first k engines could exceed the supply. This choice could lead to an infeasible set of commitments.

Case 2: “too little”

Set: S₂=ATP₁, S₃=ATP₂, . . . , Sₖ₋₁=ATPₖ but Sₖ<ATPₖ₋₁

Assume that all ATPₖ is consumed by new demands of priority k. NATPₖ will be equal to Sₖ. NATP₁=S₁−ATP₁

NATP₂=S₂−ATP

. . .

NATPₖ=Sₖ−ATPₖ=Sₖ (because ATPₖ is now 0)

Adding these together gives:

NATP₁+NATP₂+ . . . +NATPₖ=S₁−(ATPₖ₋₁−Sₖ)<S₁

If there is no ATP in the k^{th} engine, the sum of all NATPs up to k ought to be equal to the total supply available. If Sₖ is set to a value less than ATPₖ₋₁, the k^{th} engine may show no ATP even though not all supply has been exhausted. In other words, this choice could lead to sub-optimal promises, i.e., promises that are needlessly late or short.

In short, the choice of Sₖ to be ATPₖ₋₁ is the optimal choice.

Applying these rules to the engine of priority 2 in the example above yields an initial context of:

TABLE 4
Initial state of ATP engine 2

| | 1 | 2 | 3 | 4 | 5 | 6 | 7 | 8 | 9 | 10 | 11 | 12 | 13 |
|---|---|---|---|---|---|---|---|---|---|---|---|---|---|
| Planned Supply | 60 | 0 | 70 | 0 | 35 | 0 | 20 | 0 | 5 | 0 | 30 | 0 | 0 |
| Committed Demand (2) | | 30 | | 10 | | 10 | | 5 | | 30 | | | |
| Cum. Planned Supply | 60 | 60 | 130 | 130 | 165 | 165 | 185 | 185 | 190 | 190 | 220 | 220 | 220 |
| Cum. Committed Demand | 0 | 30 | 30 | 40 | 40 | 50 | 50 | 55 | 55 | 85 | 85 | 85 | 85 |
| Projected Inventory | 60 | 30 | 100 | 90 | 125 | 115 | 135 | 130 | 135 | 105 | 135 | 135 | 135 |
| ATP | 30 | 30 | 90 | 90 | 105 | 105 | 105 | 105 | 105 | 105 | 135 | 135 | 135 |
| NATP | 30 | 30 | 40 | 40 | 60 | 60 | 80 | 80 | 85 | 85 | 85 | 85 | 85 |
| Incremental ATP | 30 | 0 | 60 | 0 | 15 | 0 | 0 | 0 | 0 | 0 | 30 | 0 | 0 |

The engine of priority 3 in the example above has initial context:

TABLE 5
Initial state of ATP engine 3

| | 1 | 2 | 3 | 4 | 5 | 6 | 7 | 8 | 9 | 10 | 11 | 12 | 13 |
|---|---|---|---|---|---|---|---|---|---|---|---|---|---|
| Planned Supply | 30 | 0 | 60 | 0 | 15 | 0 | 0 | 0 | 0 | 0 | 30 | 0 | 0 |
| Committed Demand (3) | | 10 | | 30 | | 15 | | 5 | | 15 | | | |
| Cum. Planned Supply | 30 | 30 | 90 | 90 | 105 | 105 | 105 | 105 | 105 | 105 | 135 | 135 | 135 |
| Cum. Committed Demand | 0 | 10 | 10 | 40 | 40 | 55 | 55 | 60 | 60 | 75 | 75 | 75 | 75 |
| Projected Inventory | 30 | 20 | 80 | 50 | 65 | 50 | 50 | 45 | 45 | 30 | 60 | 60 | 60 |
| ATP | 20 | 20 | 30 | 30 | 30 | 30 | 30 | 30 | 30 | 30 | 60 | 60 | 60 |
| NATP | 10 | 10 | 60 | 60 | 75 | 75 | 75 | 75 | 75 | 75 | 75 | 75 | 75 |
| Incremental ATP | 20 | 0 | 10 | 0 | 0 | 0 | 0 | 0 | 0 | 0 | 30 | 0 | 0 |

Each engine does not consider commitments made by lower priority engines. A promise made by each engine to a new demand of its priority could create infeasibility in lower-priority engines if the material that it promises to that demand had been actually committed by some lower priority engine. The change in ATP in the current engine necessitates suitable adjustments to the context of the engine of the next priority. If that lower priority engine goes infeasible, feasibility is restored by delaying and/or de-committing some or all inventory in that engine. This process is repeated all the way down to the lowest priority engine.

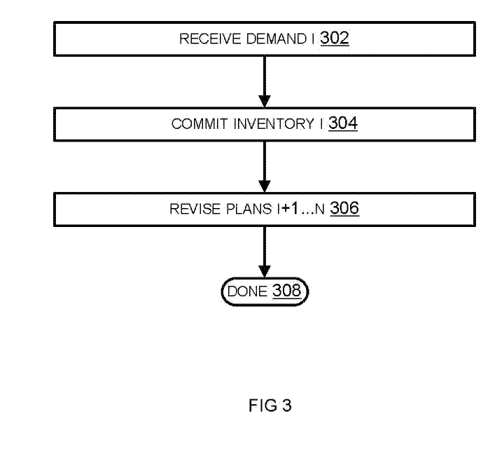

FIG. 3 is a flow chart of an embodiment of a high-level process of allocating prioritized demand. A demand is received having a priority i (302). A priority i inventory commitment is made (304). The engine contexts for lower priorities, i.e. i+1 . . . N are revised (306), where N is the lowest priority level (highest priority number). The process concludes (308).

In the above example, the highest priority engine has the entire supply available. Commitments made to priority 1 demands will not conflict with earlier commitments to demands of priority 1 as long as it is done within bounds of ATP.

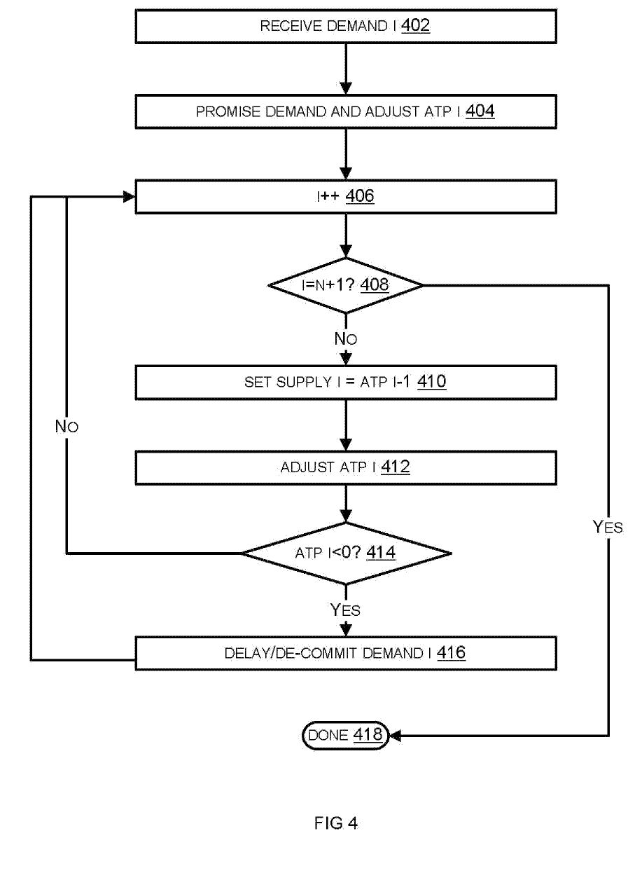

Promises made to new demands of priority 1 may conflict with prior commitments to demands of priority 2 or below. FIG. 4 is a flow chart of an embodiment of a process of allocating prioritized demand. A promise made to a new demand of priority k (402) reduces the IATP in the k^{th} engine (404), which in turn reduces the planned supply as seen by the engine (k+1). A reduction in planned supply of the engine (k+1) may cause the projected inventory, hence ATP, in engine (k+1) to go negative (406), indicating that the promise made to the latest priority k demand stole material that had been previously committed to one or more priority k+1 demands. If this should happen, delay and/or de-commit some of the inventory of priority k+1 that had previously been committed to demands (408). These adjustments may be carried out in accordance with the techniques described in the '436 application. These adjustments return the k+1 engine to feasibility. The ATP of the k+1 engine is adjusted, the revised IATP of the k+1 engine is passed on to the k+2 engine, and so on (410-416) until all the engines are feasible.

In general, the supply available to the k^{th} engine is the ATP of the k−1^{th} engine. The k^{th} promising engine responds to a demand of priority k by promising its available ATP. Any feasible promise made by this engine may not conflict with promises made to demands of higher priority (i.e. demands of priority 1 . . . k−1). No engine makes a promise that will conflict with promises made for demands of priority higher than the ones it deals with.

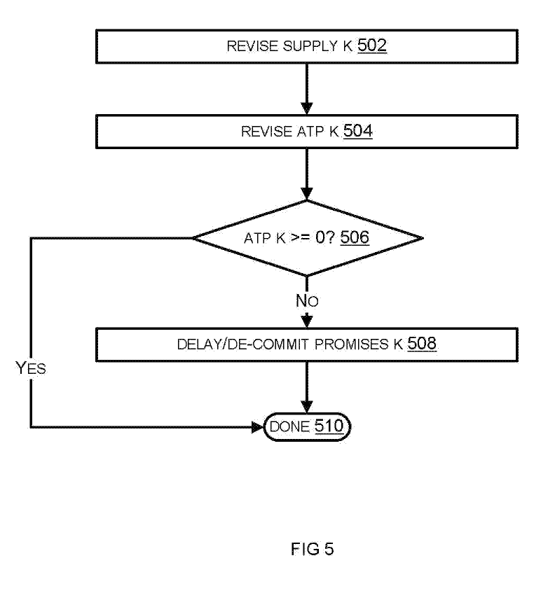

FIG. 5 is a flow chart of an embodiment of a process for making an engine for a particular priority feasible. As part of making a promise, the ATP for engine k is decremented by the amounts committed to the new demand. The revised ATP for engine k results in a revision of the planned supply for the k+1^{th} engine (502). This results in the revision of the ATP of the k+1^{th} engine (504). If the ATP of the engine k+1 remains non-negative (506), no further action is required in engine k+1. If the ATP of the engine k+1 goes negative, delay and/or de-commit some of the orders of priority k+1 that had previously been committed (508). These adjustments may be made in manners consistent with the techniques described in the '436 application. Making these adjustments returns the k+1^{th} engine to feasibility. The above process ends (510) when the engine dealing with the lowest priority demands has been made feasible.

For a numerical example, introduce a demand of priority 1 of 25 units due at time t=2. At the time of the receipt of this demand, the 1^{st} engine has an ATP of 60 units at time t=1, so it can make a promise for the entire amount on time. This changes the context of the 1^{st} engine to:

TABLE 6
State of ATP engine 1 after committing to an order of 25 units due at time t = 2

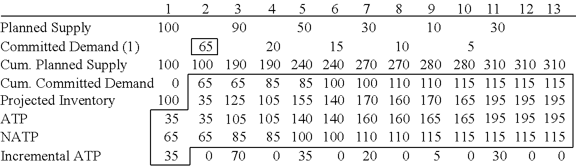

The changes are the effect of a demand due at time t=2 causing a reduction in the ATP in time t=1. Specifically, the IATP at time t=1 has been reduced from 60 to 35 due to the commitment of 25 units at time t=2.

This change in the IATP in the 1^{st} engine is propagated to the 2^{nd} (priority 2) engine. This causes the second engine to change context:

TABLE 7
State of ATP engine 2 after adjustments to the supply seen by it

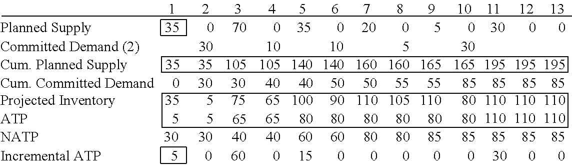

The decrease of 25 units at time t=1 in the planned supply for the 2^{nd} engine causes a decrease in its IATP at that time. This decrease in the planned supply does not cause the projected inventory to go negative, hence the new promise did not disrupt any promises of priority 2 made earlier. This decrease in IATP is propagated to the 3^{rd} (priority 3) engine. This causes the third engine to change context:

TABLE 8
State of ATP engine 3 after adjustments to the supply seen by it

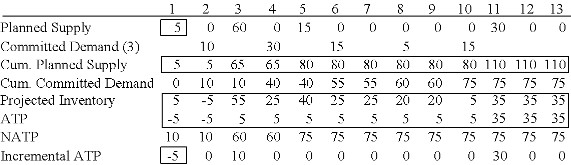

The decrease in planned supply to this engine causes the projected inventory (and ATP) to go negative at time t=2. The new promise of 25 units made to the demand of priority 1 by the 1^{st} engine actually came at the expense of the feasibility of the priority 3 engine. The higher priority demand pre-empts the commitment made to demands of lower priority. The engine of lower priority (in this case engine 3)) determines how the resulting infeasibility is resolved. In this case, the commitment made by the 1^{st} engine in response to the new demand does not upset the feasibility of the engine 2, but the engine 3 does become infeasible. It is left to the 3^{rd} engine to resolve the infeasibility caused by the commitment made by the 1^{st} engine.

The negative inventory problem may be addressed using approaches consistent with those described in the '436 application. In this case, engine 3 will split the commitment of 10 units at time t=2 and delay half of it to time t=3.

When a demand order of priority k is canceled, there is no effect on the context of higher priority engines (engines k−1 . . . 1). This is because those engines did not “see” (i.e. take into account) this demand in the first place.

If a demand of priority k is canceled, cancellation techniques consistent with those described in the '436 application may be applied in some embodiments. This restores the ATP optimally, thereby allowing subsequent demands of priority k to take full advantage of the increased availability.

The restoration of ATP at the k^{th} engine may create an opportunity to improve the promises made by it to demands received earlier that could not be fulfilled on time. After the engine avails itself of this opportunity, there will be a new ATP profile which may or may not be different from the earlier ATP. If it is different, it will be more than what it was earlier. This means that the supply seen by the k+1^{th} engine increases. This results in the increase in the ATP of the k+1^{th} engine. This process is applied repeatedly until the last (lowest priority) engine is reached or until there is no change in the ATP of an engine.

Exemplary Apparatus

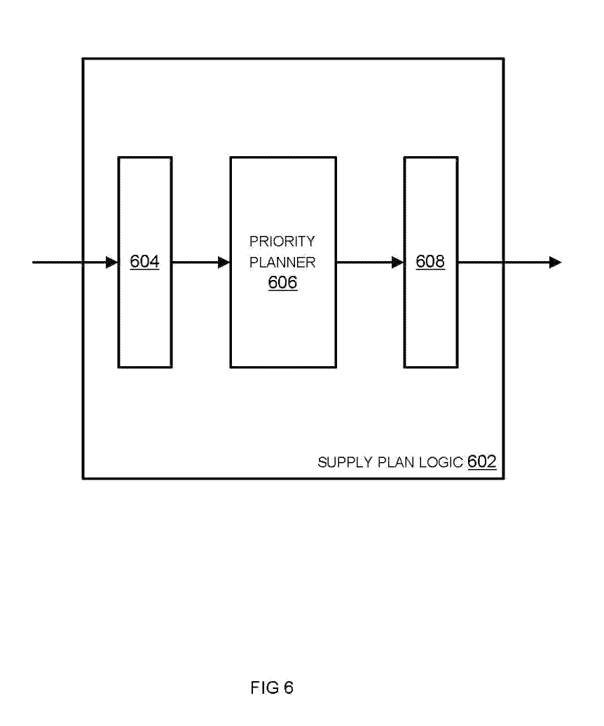

An exemplary embodiment of an apparatus to implement aspects of the supply chain management techniques described herein is illustrated in FIG. 6. The apparatus 602 includes interface logic 604 to receive electrical and/or electromagnetic signals representing supply events for real world objects with the supplied quantities and times at which the supply events will occur. The same or different interface logic 604 may also receive electrical and/or electromagnetic signals representing demand events for the real world objects and times and which the demand events will occur. Priority planning logic 606 includes logic to associate priorities to the demand events. Demand events may be received via interface 604 with priorities already associated, or the priority planner 606 may ascertain the demand event's priority from other factors, such as the source of the demand, the timing of the demand, the quantity of the demand, and/or combinations of these and/or other factors. The priority planner 606 may comprise logic to determine, for each demand event priority, an available to promise (ATP) amount of supply in accordance with demand events of that priority, where the ATP is determined for higher priority demand events before it is determined for lower priority demand events. The apparatus 602 further comprises logic to communicate signals representing supply and/or demand amounts of real world objects to an electro-optical display device. These signals may represent values for supply and demand amounts at particular times as received from the priority planner 606.

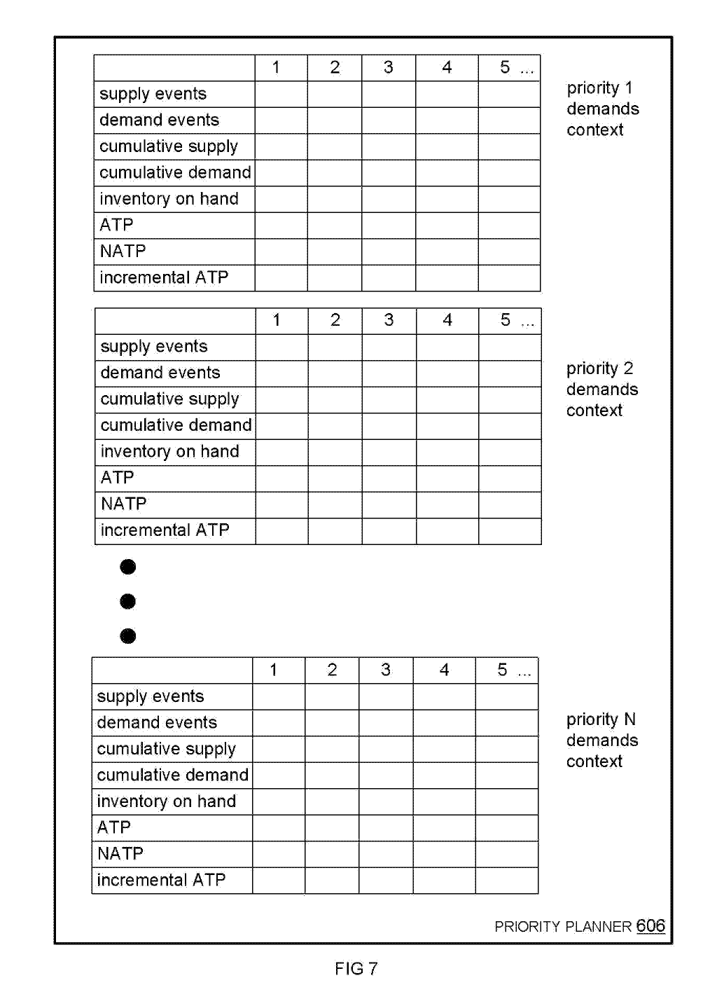

FIG. 7 illustrates a more detailed exemplary embodiment of an apparatus to implement aspects of the supply chain management techniques described herein. A separate device memory context is maintained for each demand priority level. A memory context is a set of associated data stored in electronic, optical, magnetic, or other types of device memory. The memory context comprises the data and linking information that associates the data into subsets, e.g. columns and/or rows of a data table, linked lists, queues, vectors and arrays, etc. Within each context are supply events and demand events each associated with quantities and times at which these events have or will take place. Also associated with supply/demand events are cumulative supply up to that time (at least with each supply event), cumulative committed demand up to that time (at least with each demand event), projected inventory, ATP, NATP, and incremental ATP. Alternative embodiments may compute some of these context values at the corresponding event ‘on the fly’ from other maintained context values. Some embodiments may comprise values of incremental NATP (INATP) and ATPRG in the context maintained per priority level.

Implementations and Alternatives

The techniques and procedures described herein may be implemented via logic distributed in one or more computing devices. The particular distribution and choice of logic is a design decision that will vary according to implementation.

“Logic” refers to circuits (e.g. memory circuits) embodying signals and/or information that may be applied to influence the operation of a device. Software, hardware, and firmware are examples of logic. In general, logic may comprise combinations of software, hardware, and/or firmware.

Those skilled in the art will appreciate that logic may be distributed throughout one or more devices, and/or may be comprised of combinations of instructions in memory, processing capability, circuits, and so on. Therefore, in the interest of clarity and correctness logic may not always be distinctly illustrated in drawings of devices and systems, although it is inherently present therein.

Those having skill in the art will appreciate that there are various logic implementations by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. An apparatus comprising:
interface logic to receive electrical and/or optical signals representing supply events for real world objects with supplied quantities and times at which the supply events will occur;
interface logic to receive electrical and/or optical signals representing demand events for the real world objects with demanded quantities and times and which the demand events will occur;
logic to associate priorities to the demand events;
logic to determine, for each demand event priority, an available to promise (ATP) amount of supply in accordance with demand events of that priority;
wherein the ATP is determined for higher priority demand events before it is determined for lower priority demand events; and
logic to form, in a device memory, a context for each demand priority.

2. The apparatus of claim 1, further comprising:
logic to apply a demand for inventory of priority k to determine incremental ATP for demands of priority k.

3. The apparatus of claim 2, further comprising:
logic to apply the incremental ATP for demands of priority k to adjust the ATP of demands of priority k+1, where lower values of k represent higher priority demands.

4. The apparatus of claim 1, further comprising:
logic to use the ATP for demands of priority k in order to respond to demands of priority k, without regard to the ATP for demands of other priorities.

5. An apparatus comprising:
interface logic to receive electrical and/or optical signals representing supply events for real world objects, the supply events comprising supply times and supply amounts;
interface logic to receive electrical and/or optical signals representing demand events for the real world objects, the demand events comprising demand times and demand amounts;
logic to associate different priorities to different demands;
logic to form, in a machine memory, a context for each demand priority;
logic to adjust demand priority context (k) in response to a new demand event of priority k;
logic to adjust the demand priority contexts k+1 to N in response to the new demand event, where N is the number of demand priority contexts and priority k is higher than priority k+1;
logic to make feasible any demand priority context k+1 to N that is rendered infeasible by the new demand event.

6. The apparatus of claim 5, further comprising:
logic to adjust the incremental ATP for demand priority context k to account for the new demand event of priority k.

7. The apparatus of claim 6, further comprising:
logic to apply the incremental ATP for demand priority context k to adjust the ATP of demand priority context k+1.

8. The apparatus of claim 5, further comprising:
logic to adjust the ATP of demand priority context k, in response to the new demand of priority k, without regard to the ATP of other demand priority contexts.

9. The apparatus of claim 5, further comprising:
logic to identify a range of nonzero ATPRG values in a demand priority context k immediately prior to a time of a cancelled order for inventory of demand priority k; and
while there is remaining inventory committed to the cancelled order, for each demand priority context i=k+1 to N, logic to determine an amount of inventory to restore to available status at a particular supply event based upon a minimum ATPRG value between the particular supply event and the order committed date.

10. The apparatus of claim 9, further comprising:
for each demand priority context i=k+1 to N, logic to update ATPRG values between the order committed date and the particular supply event according to the amount of inventory restored at the particular supply event.
